(19) United States
(12) Patent Application Publication
(10) Pub. No.: US 2008/0092333 A1
(43) Pub. Date: Apr. 24, 2008

(54) Hinge for furniture provided with a shock absorber and shock absorber for a hinge

(76) Inventor: Carlo Migli, Lecco LC (IT)

Correspondence Address: JACOBSON HOLMAN PLLC, 400 SEVENTH STREET N.W., SUITE 600, WASHINGTON, DC, 20004, US

(21) Appl. No.: 11/907,662

(22) Filed: Oct. 16, 2007

(30) Foreign Application Priority Data
Oct. 18, 2006 (IT) MI2006A 001999

(51) Int. Cl. E05D 7/00; F16F 9/00

(52) U.S. Cl. 16/221; 188/266

(57) ABSTRACT

A hinge for furniture comprises a first part to be fastened to a first furniture element and a second part to be fastened to a second furniture element, said first and second hinge parts being rotatably in engagement with each other, a shock absorber being present which comprises a body fastened to the first hinge part and a shock absorbing member movably mounted on said body, the shock absorbing member being adapted to restrain movement of the second hinge part in a closing step of the hinge. Said shock absorbing member and second hinge part having portions magnetically attracting each other to carry out dragging along of the shock absorbing member relative to the body during a reopening step of the hinge, bringing said member back to position for subsequent cushioning of the closing movement of the hinge.

### BACKGROUND OF THE INVENTION

1. Field of the Invention

The present invention relates to an innovative cushioned hinge for furniture and to a shock absorber for hinges.

2. State of the Prior Art

Application of shock absorbers to hinges for furniture is known in the art, for example hinges of the type comprising a wing to be fastened to the furniture frame and a bowl-shaped element to be anchored into a cavity in the furniture door.

The shock absorber can be mounted in such a manner as to act between the wing and the bowl-shaped element during a final step of the closing movement of the hinge, to prevent the door from knocking against the furniture frame with violence.

According to a known technique, a shock absorber of the hydraulic type can be used. While this solution enables a good cushioning or damping effect to be achieve, it involves use of a component of complicated and relatively expensive manufacture.

As an alternative to hydraulic shock absorbers, use of shock absorbers of the pneumatic type has been suggested, which comprise a cylindrical chamber inside which a piston provided with a seal can slide. The chamber is fastened to a hinge element, while the piston is such disposed that it comes into contact with the other hinge element to cushion the final closing movement of the hinge.

Disposed within the chamber is a spring designed to bring the piston back to the forwardly extended starting location when the door is brought to the opening position, so that the shock absorber is ready to perform its cushioning function on the subsequent closing movement of the door.

This solution of the known art however, does not allow a satisfactory cushioning effect to be achieved in the event of a violent closure of the door.

Actually, the spring for reloading disposed within the cylinder chamber has some bulkiness also in the position of maximum compression with the piston at the end of its stroke. This does not allow a minimum volume close to zero of the chamber to be achieved and, consequently high damping forces between the hinge parts to be developed on closure, since the maximum pressure value in the shock absorber is relatively low.

The present invention aims at eliminating the above mentioned drawbacks by providing a cushioned hinge enabling a satisfactory cushioning action to be developed in a final closing step of the hinge.

It is a further aim of the invention to provided a cushioned hinge having a limited bulkiness and a simple and cheap structure.

### SUMMARY OF THE INVENTION

In view of the above aim, in accordance with the invention a hinge for furniture has been conceived which comprises a first part to be fastened to a first furniture element and a second part to be fastened to a second furniture element, said first and second hinge parts being rotatably in engagement with each other, a shock absorber being present which comprises a body fastened to the first hinge part and a shock absorbing member mounted in a movable manner on said body, the shock absorbing member being adapted to restrain movement of the second hinge part during closure of the hinge, characterized in that said shock absorbing member and second hinge part have portions magnetically attracting each other to carry out dragging along of the shock absorbing member relative to the body during a reopening step of the hinge, bringing said member back to position for subsequent cushioning of the closing movement of the hinge.

Still in accordance with the invention, a shock absorber for hinges has been provided of the type comprising two parts rotatably in engagement with each other and each designed to be fastened to one of the two furniture elements, the shock absorber comprising a body adapted to be fastened to a first hinge part and a shock absorbing member movably mounted on said body, the shock absorbing member being designed to restrain movement of the second hinge part during closure of the hinge, characterized in that a magnet is mounted on said shock absorbing member to generate a magnetic attraction between the shock absorbing member and the second hinge part so as to carry out dragging along of the shock absorbing member relative to the shock absorber body during a reopening step of the hinge, bringing said member back to position for subsequent cushioning of the closing movement of the hinge.

### BRIEF DESCRIPTION OF THE DRAWINGS

For better explaining the innovative principles of the present invention and the advantages it offers over the known art, a possible embodiment applying these principles will be described hereinafter by way of example, with the aid of the accompanying drawings. In the drawings:

FIG. 1 is a perspective view of a hinge provided with a shock absorber in accordance with the invention,

FIG. 2 is an exploded view of the shock absorber shown in FIG. 1,

FIG. 3 is a section view of the hinge seen in FIG. 1, showing the hinge in a partly open position,

FIG. 4 is a section view similar to the preceding one, in a closed position of the hinge,

FIG. 5 is a section view of an alternative embodiment of the hinge of the invention,

FIG. 6 is a section view of the hinge seen in FIG. 5 in a closed position.

### DETAILED DESCRIPTION OF THE INVENTION

With reference to the drawings, a hinge 11 is shown which is designed to connect two furniture elements in a rotatable manner, such as a pivoting-leaf door with respect to a wardrobe or cabinet frame.

Hinge 11 comprises two parts 12 and 13 in engagement with each other in a rotatable manner, each of which is adapted to be fastened to one of the two furniture elements.

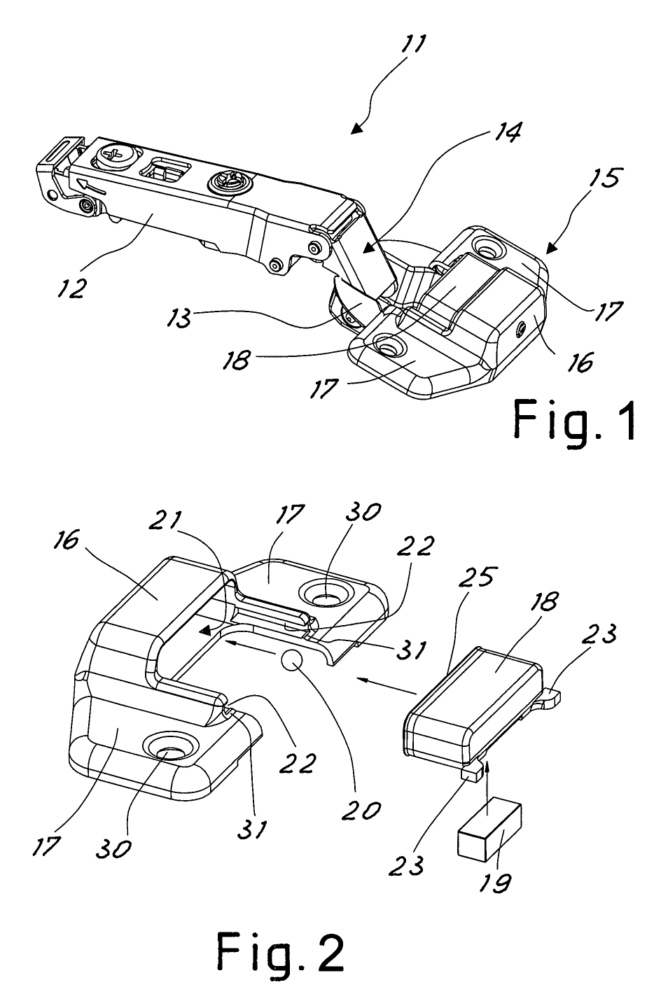

In the embodiment in FIG. 1, part 12 is made in the form of a wing to be fastened to the furniture frame (not shown), while part 13 is made up of a bowl-shaped element adapted to be fastened into a cavity formed in the furniture door (not shown). The wing 12 and bowl-shaped element 13 are rotatably connected to each other by a pivot system of the articulated type 14, made following well-known techniques in this field. The wing 12 and bowl 13 are of ferromagnetic material.

A known spring system can be disposed at the inside of wing 12, which system enables automatic closure of the door when the latter is let free in the vicinity of the closing angle.

According to the embodiment in FIGS. 1-4, the hinge is provided with a shock absorber 15 comprising a body 16 fastened to the bowl-shaped element 13 and a movable shock absorbing member 18 that is mounted on body 16 so that it can slide relative thereto. Member 18 is adapted to come into contact with wing 12 in a final step of the closing movement of the hinge, so as to restrain movement thereof and avoid violent knocking of the door against the furniture frame.

Advantageously, the shock absorber 15 is of the pneumatic type and body 16 forms a chamber 21 inside which the movable member 18 slides, which member consists of a piston provided with a seal 25 on the perimeter of its rear end facing chamber 21.

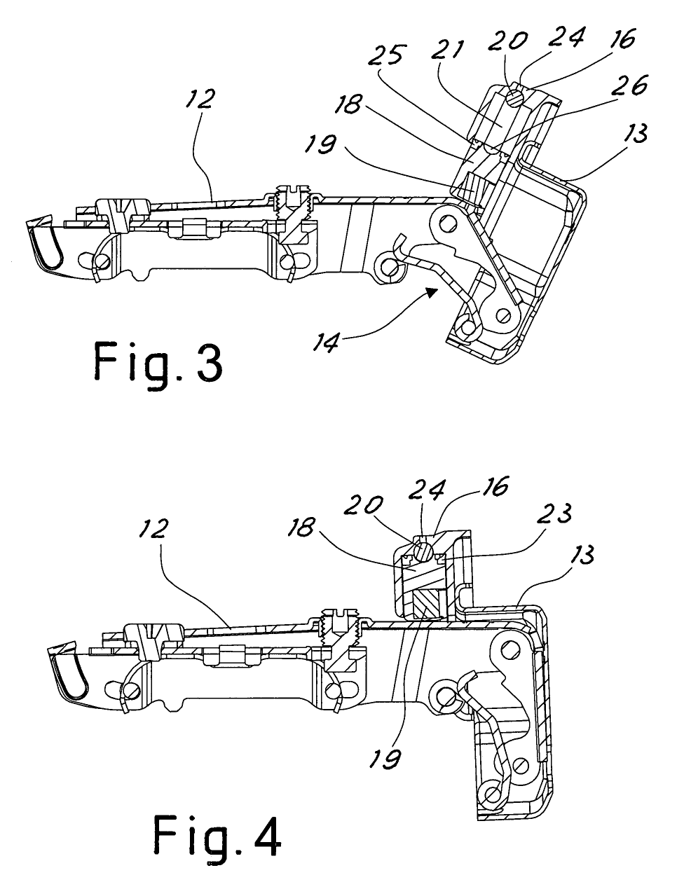

A vent hole 24 is formed in the bottom of chamber 21, as clearly shown in FIGS. 3 and 4, and the compressed air present in the chamber slowly goes out through said hole 24 on quick closure of the hinge. A ball 20 is embedded in body 16 at hole 24, so as to form the desired air escape port.

Body 16 is provided with a pair of side flanges 17 jutting out on opposite sides of the element, which flanges are designed to overlap corresponding flanges of the bowl-shaped element 13 of the hinge so as to be anchored thereto. Fastening holes 30 are provided in body 16 at flanges 17. Said body 16 can be secured to the bowl following any known technique, by means of rivets but also with a known clip system.

Piston 18, as viewed from the figures, can slide in a direction parallel to the furniture door plane and transverse to the pivot axis of the hinge.

Formed in body 16 is a pair of guide grooves 22 inside which tongues 23 slide, which tongues laterally project on opposite sides of piston 18 at the front end thereof facing the outside of the shock absorber.

Stop limit teeth 31 are formed at the front end of grooves 22, in order to confine the piston stroke towards the outside of the shock absorber.

At its front end designed for contact with wing 12, piston 18 carries a magnet 19 that is advantageously inserted in a cavity opening on the piston side surface extending transversely of the sliding direction of the piston. Magnet 19 can be embedded into the cavity in piston 18 to be locked therein.

Formed in the rear end of piston 18 is an almost hemispheric concavity adapted to house ball 20 when piston 18 reaches its stop limit position.

Shown in FIGS. 3 and 4 respectively is a partly open condition of hinge 11, with an opening angle approximately corresponding to that at which the automatic-closure spring starts working, and a fully closed condition.

In FIG. 3 piston 18 is in its forward maximum-extension position at the end of its stroke and wing 12 is in contact with the front portion of piston 18, during a closing step of the hinge, for example.

Going on to the closed position, the piston is pushed to the position shown in FIG. 4 where the inner volume of chamber 21 is almost zero, or at all events very reduced, and the rear piston end is at the bottom of cavity 21. Moving from the position in FIG. 3 to that in FIG. 4, the piston carries out a restraining action on the closing movement of the hinge by a pneumatic effect.

Air discharge slowly takes place through hole 24 and in case of quick closure of the furniture door, a high pressure is generated when piston 18 comes close to its end of stroke, thus giving rise to a high cushioning stroke.

On reopening of the hinge, the magnetic interaction between wing 12 made of iron and magnet 19 mounted on piston 18 causes the piston to be dragged along again to the position in FIG. 3, while remaining in contact with wing 12 over the starting stretch of the opening movement. The cavity wall receiving magnet 19 and facing the piston head is made thin so as to limit the distance between magnet and iron to the minimum, enabling a magnetic attraction force to be generated that is sufficient to overcome the resistant friction between seal 25 and inner wall of cavity 21. The pneumatic resistance during reloading is made minimum due to the particular shape of the seal lip having such a deformability that the sealing effect during expansion of chamber 21 is reduced.

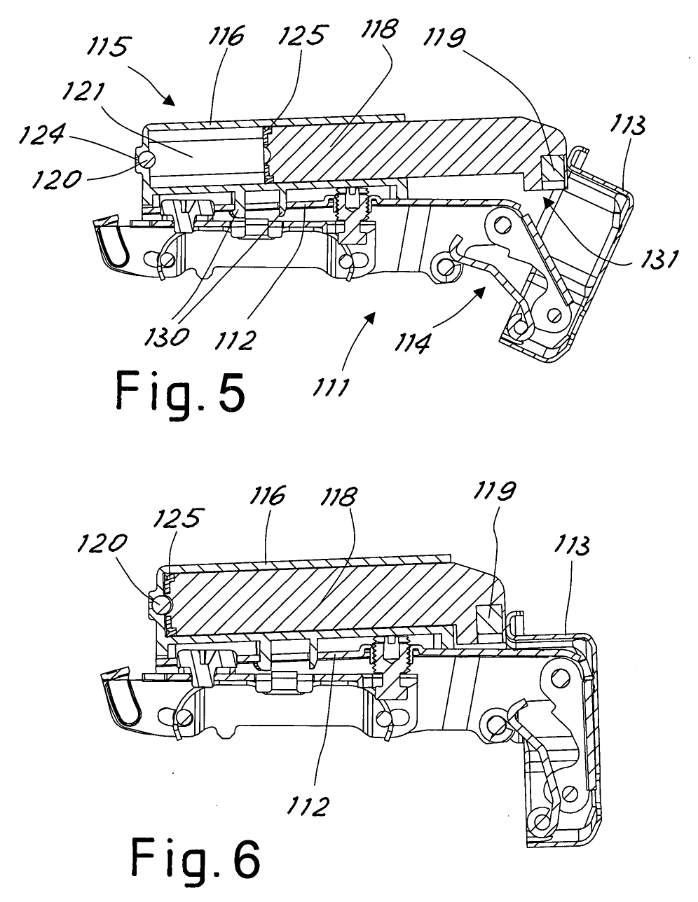

Shown in FIGS. 5 and 6 is an alternative embodiment of the invention where the shock absorber 115 is applied to a hinge 111 consisting of a bowl 113 and a wing 112 in engagement with each other in the same manner as in the embodiment in FIGS. 1 and 4 through a pivot system of the articulated type 114.

Body 116 of the shock absorber in this case is fastened to the hinge wing 112 and the movable shock absorbing member 118 is adapted to contact bowl 113 on closing of the hinge to restrain a quick and violent closing movement of the hinge (and therefore of the furniture door).

The shock absorber 115 is of the air type; body 116 forms a chamber 121 within which the shock absorbing member 118 can slide, said member 118 being in the form of a piston provided with a seal 125 on its rear end facing the inside of cavity 121.

Body 116 is provided with a vent hole 124 at the bottom, in which a ball 120 is embedded, in the same manner as in the preceding embodiment.

The body is fastened to wing 112 through known fitting means 130 suitable for engagement in suitable seats formed in the wing itself. Chamber 121 and piston 118 extend almost in parallel to wing 112, as shown in the figure.

Piston 118 carries a magnet 119 on its front end, said magnet being inserted in a cavity extending transversely of the movement direction of piston 118, in the same manner as the previously described piston 18.

Advantageously, at the front end, piston 118 comprises a portion 131 that laterally projects relative to its longitudinal extension in the direction of hinge 111, so as to enable correct contact of the piston head with the bowl 113 during the closing step of the hinge.

Shown in FIG. 5 is the hinge in a position near closure, when piston 118 starts contacting the bowl, while in FIG. 6 the hinge is shown in a closed position, the piston being at the end of its stroke. On reopening, piston 118 is dragged along to the starting position of FIG. 5 due to the magnetic attraction between the bowl 113 iron and magnet 119, being ready for cushioning on occurrence of a further closure of the hinge.

At this point it is apparent that the inventive purposes are achieved.

In particular a hinge capable of exerting a high damping force by means of a shock absorber of simple and cheap structure is provided.

Using a magnetic interaction for reloading the movable shock absorbing member, use of reloading springs inside the piston chamber is not required in the case of the air shock absorber and it is therefore possible to obtain high damping forces due to the limited volume of the chamber with the piston at the end of its stroke.

Obviously, the above description of an embodiment applying the innovative principles of the present invention is given by way of example only and therefore must not be taken as a limitation of the scope of the patent rights as herein claimed.

What is claimed is:

1. A hinge for furniture comprising a first part to be fastened to a first furniture element and a second part to be fastened to a second furniture element, said first and second hinge parts being rotatably in engagement with each other, a shock absorber being present which comprises a body fastened to the first hinge part and a shock absorbing member movably mounted on said body, the shock absorbing member being adapted to restrain movement of the second hinge part during a closing step of the hinge, characterized in that said shock absorbing member and second hinge part have portions magnetically attracting each other to carry out dragging along of the shock absorbing member relative to the body during a reopening step of the hinge, bringing said member back to position for subsequent cushioning of the closing movement of the hinge.

2. A hinge as claimed in claim 1, characterized in that the shock absorber is an air shock absorber, the body forming a chamber inside which a piston embodying the shock absorbing member can slide.

3. A hinge as claimed in claim 2, characterized in that the chamber with the piston at the end of its stroke has a volume close to zero.

4. A hinge as claimed in claim 2, characterized in that the chamber is provided with an air vent hole at its bottom end.

5. A hinge as claimed in claim 1, characterized in that a magnet is mounted on the shock absorbing member, the second hinge part being made of a ferromagnetic material.

6. A hinge as claimed in claim 5, characterized in that the magnet is mounted on the shock absorbing member close to a front end thereof designed to contact the second hinge part.

7. A hinge as claimed in claim 5, characterized in that the magnet is insertable transversely of a movement direction of the shock absorbing member into a cavity opening on a side surface thereof.

8. A hinge as claimed in claim 1, characterized in that the two hinge parts comprise an elongated wing to be fastened to a furniture frame and a bowl-shaped element insertable into a cavity formed in a furniture door.

9. A hinge as claimed in claim 8, characterized in that the shock absorber body is fastened to the bowl-shaped element of the hinge.

10. A hinge as claimed in claim 9, characterized in that the bowl comprises two flanges on opposite sides for fastening to the furniture element, the shock absorber body comprising two flanges as well, which are adapted to overlap the flanges of the bowl-shaped element to be secured thereto.

11. A hinge as claimed in claim 8, characterized in that the shock absorber body is fastened to the hinge wing.

12. A hinge as claimed in claim 11, characterized in that the shock absorber is an air shock absorber, the body forming a chamber inside which a piston embodying the shock absorbing member can slide and the piston is disposed parallel to the hinge wing.

13. A hinge as claimed in claim 2, characterized in that the piston on a front end thereof opposite to the chamber is provided with a pair of guide tongues jutting out on opposite sides of the piston and adapted to slide along guide grooves formed in the shock absorber body.

14. A hinge as claimed in claim 1, characterized in that the hinge is an articulated hinge.

15. A shock absorber for hinges of the type comprising two parts rotatably in engagement with each other and each designed to be fastened to one of the two furniture elements, the shock absorber comprising a body adapted to be fastened to a first hinge part and a shock absorbing member movably mounted on said body, the shock absorbing member being designed to restrain movement of the second hinge part during closure of the hinge, characterized in that a magnet is mounted on said shock absorbing member to generate a magnetic attraction between the shock absorbing member and the second hinge part so as to carry out dragging along of the shock absorbing member relative to the shock absorber body during a reopening step of the hinge, bringing said member back to position for subsequent cushioning of the closing movement of the hinge.
